(19) United States
(12) Patent Application Publication
(10) Pub. No.: US 2020/0397638 A1
(43) Pub. Date: Dec. 24, 2020

(54) Cremation vessel and display

(71) Applicants: Anthony George Bell, Hilton Head Island, SC (US); Edward Aldridge Maddox, Linwood, NJ (US)

(72) Inventors: Anthony George Bell, Hilton Head Island, SC (US); Edward Aldridge Maddox, Linwood, NJ (US)

(21) Appl. No.: 16/501,865

(22) Filed: Jun. 19, 2019

(51) Int. Cl. A61G 17/08

(52) U.S. Cl. CPC A61G 17/08

(57) ABSTRACT

Described herein is a cremation vessel and display device.

### FIELD OF THE INVENTION

The invention relates generally to an improved cremation vessel and display device.

### BACKGROUND

Currently there are a number of solutions for storing the ashes of the deceased after cremation of their remains. One of these solutions attempts to utilize an urn, but this solution fails to meet the needs of the market because the urn may be stored away, hidden and forgotten. Another solution attempts to scatter the ashes of the loved one, but this solutions is similarly unable to meet the needs of the market because there are legal restraints as to where a loved one can be scattered. Still another solution seeks to store the remains of the loved one within a larger structure, such as a mausoleum, with other cremated individuals, but this solution also fails to meet market needs because the remains of the loved one are often stored out of sight.

### SUMMARY OF THE INVENTION

It would be advantageous to have an apparatus that kept a loved one in an improved urn. Furthermore, it would also be advantageous to have an apparatus that was on display and not in storage. Still further, it would be advantageous to have an apparatus that was configured as an addition of art to the room the apparatus is placed within. Further, it would be advantageous to have a device that was portable, configured for indoor or outdoor use, and generally provided flexibility and adaptability in providing a customized device for storing and displaying the remains of a loved one. Therefore, there currently exists a need in the market for an apparatus that was customizable to fit the needs and wants of the family and the wishes of a loved one.

The invention advantageously fills the aforementioned deficiencies by providing a cremation vessel and display, which provides for multiple customizable features.

The invention is customizable and configured to allow a user to upgrade the device at a later time if desired.

The apparatus has a key lock.

The apparatus has an urn base.

The apparatus fulfills the need for options for the family to remember a loved one in a customizable and unique display.

Among other things, it is an advantage of the invention to provide a cremation vessel and display that does not suffer from any of the problems or deficiencies associated with prior solutions.

It is still further an advantage of the invention to replace traditional fireplace urns.

Still further, the apparatus has a twist lock mechanism to insert sculptures into a top portion.

The invention now will be described more fully hereinafter with reference to the accompanying drawings, which are intended to be read in conjunction with both this summary, the detailed description and any preferred and/or particular embodiments specifically discussed or otherwise disclosed. This invention may, however, be embodied in many different forms and should not be construed as limited to the embodiments set forth herein; rather, these embodiments are provided by way of illustration only and so that this disclosure will be thorough, complete and will fully convey the full scope of the invention to those skilled in the art.

### BRIEF DESCRIPTION OF THE DRAWINGS

FIG. 1 shows the front of the device.

FIG. 2 shows the top of the device with the lid.

FIG. 3 shows a perspective view of the device with the lid.

FIG. 4 shows a perspective view of the device.

FIG. 5 shows a perspective view of the lid.

FIG. 6 shows the top of the device.

FIG. 7 shows the right side of the device's lid.

FIG. 8 shows a perspective view of the device's lid.

FIG. 9 shows a perspective view of the device's lid with cover.

FIG. 10 shows the top of the lid.

FIG. 11 shows the left side of the device's lid.

### DETAILED DESCRIPTION OF THE INVENTION

Following are more detailed descriptions of various related concepts related to, and embodiments of, methods and apparatus according to the present disclosure. It should be appreciated that various aspects of the subject matter introduced above and discussed in greater detail below may be implemented in any of numerous ways, as the subject matter is not limited to any particular manner of implementation. Examples of specific implementations and applications are provided primarily for illustrative purposes.

The invention is a customizable cremation vessel and display.

The invention is personalized.

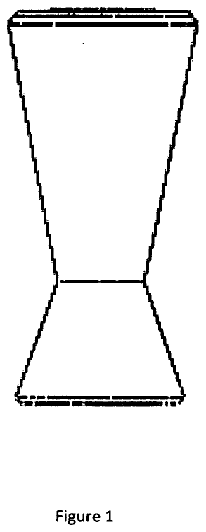

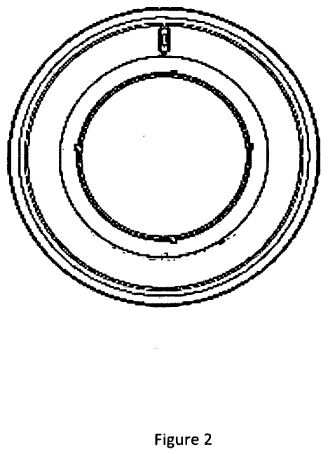

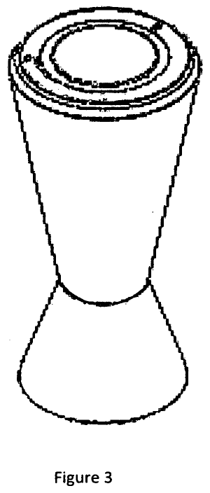

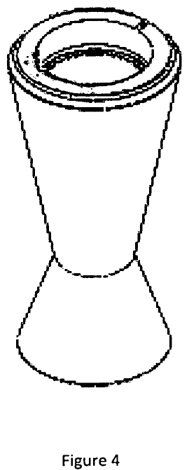

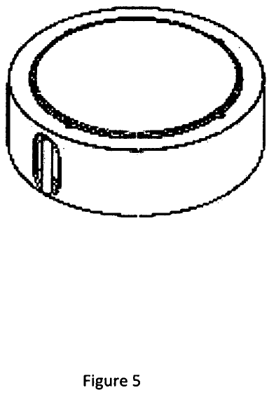

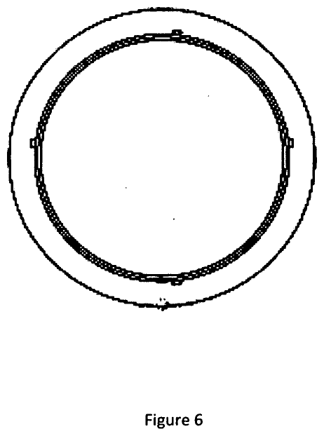

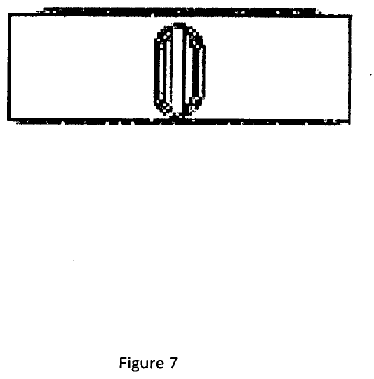

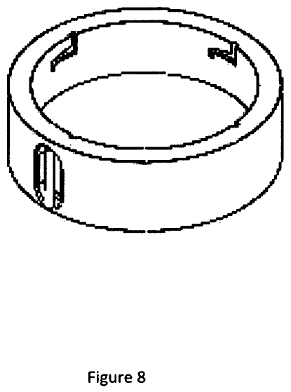

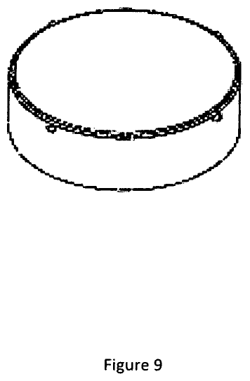

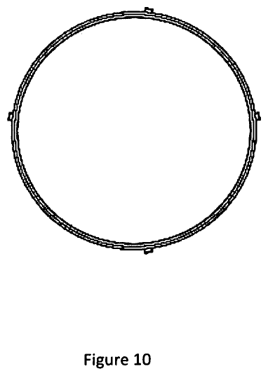

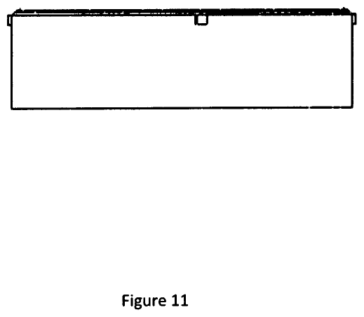

Referring to the figures, FIG. 1 to FIG. 11 show the cremation vessel and display according to the present disclosure. The device is generally adapted as a repository for the ashes of the deceased. The device including a base portion with a twist lock cap and key lock latch base to keep the device closed. The cap over the latch lock can be removed and replaced a custom design adapted to be inserted and secured. The design can by any ornamental feature or material, including, but not limited to, glass, or other similar material functioning as a sculpture top portion which is customized for the family and loved one.

Accordingly, the device generally comprises four interconnected elements in the form of the base portion for the placement of ashes and secured with a locking mechanism, a ceiling portion, an ornamental feature, and secure locking mechanism to secure the entire structure with a key. The ceiling portion positioned above the base portion and configured with a cavity to store optional functional, decorative, or mechanical features, including but not limited to, ornaments, such as glass or crystal art, projectors to provide interior illumination, static and dynamic images or holographic displays, geolocation, and a locking mechanism for securing ornamental features.

Various related embodiments of the invention are also described in Appendix A, which is incorporated herein by reference in its entirety.

While the invention has been described above in terms of specific embodiments, it is to be understood that the invention is not limited to these disclosed embodiments. Upon reading the teachings of this disclosure many modifications and other embodiments of the invention will come to mind of those skilled in the art to which this invention pertains, and which are intended to be and are covered by both this disclosure and the appended claims. It is indeed intended that the scope of the invention should be determined by proper interpretation and construction of the appended claims and their legal equivalents, as understood by those of skill in the art relying upon the disclosure in this specification and the attached drawings.

1. A vessel for the placement of cremation remains, as is herein shown and described.

2. An urn, the urn having a base portion, a ceiling portion, an ornamental portion, and a locking mechanism, as is herein shown and described.
